(19) United States
(12) Patent Application Publication
(10) Pub. No.: US 2004/0212572 A1
(43) Pub. Date: Oct. 28, 2004

(54) Display apparatus

(76) Inventors: Victor Lam, Saratoga, CA (US); Yuanyue Zhang, Milpitas, CA (US)

Correspondence Address: Victor Lam, 20510 Carniel Avenue, Saratoga, CA, 95070, US

(21) Appl. No.: 10/699,033

(22) Filed: Nov. 3, 2003

(30) Foreign Application Priority Data
Apr. 24, 2003 (CN) 03225432.6

(51) Int. Cl. G09G 3/32; G09G 3/22

(52) U.S. Cl. 345/82

(57) ABSTRACT

A display apparatus comprises of at least two stationary rotating units, which are parallel and spaced apart from each other and housed in a rigid frame with at least one opening formed as a viewing window. A flexible web is wrapped around these two rotating units, forming at least one moving viewing plane in the opening of the rigid housing. There are at least one line of light emitting elements arranged parallel to the rotating units and travels constantly through the display opening. A control unit inside the housing provides power, display data and control signal to the light emitting elements on the moving web; A communication unit provides the necessary link between the control unit and the moving web so that power, display data and control signal can be passed on to the light emitting elements causing them to display either text, or video image on the moving web, which can be viewed through the opening of the housing, thus creates a single-face display apparatus.

### BACKGROUND OF THE INVENTION

The present invention relates to a display apparatus, and particularly to a display apparatus having a rotational display panel rotating around at least two stationary units.

Conventionally, an electronic display panel is composed of a great number of light emitting pixels, each composed of single or multiple light bulb, light emitting diode (LED) or other light emitting elements. In the case of a 480×640 pixel matrix monochromatic display, it will require 307,200 pixels of single color light emitting elements. In the case of a full color display, each pixel further consists of three light emitting elements in red, green and blue color, and the total light emitting elements will be 921,600. In such a display, each pixel will either display the image information from each image frame constantly within its frame rate to gain maximum brightness; or partially to cut down the cost of driver, energy consumption and in some case, to prolong the lifetime of the light emitting elements. In the later method, a so-called ⅛ duty cycle scanning display mode, will group every 8 lines of the display panel together and each line within this grouping will display its content sequentially each using only one eighth of its predetermined display time within its frame rate, which is defined as the time duration each image frame will display.

### SUMMARY OF THE INVENTION

The object of the present invention is to use the scanning display method to provide a display apparatus, which will use only a fraction of the required light emitting elements from the above mentioned conventional electronic display panel, and thus provide great saving on the cost of such a display apparatus.

One aspect of the present invention consists of at least two stationary rotating units, which are parallel and spaced apart from each other and housed in a rigid frame with at least one opening formed between these two stationary rotating units as a viewing window for the display. A flexible web is wrapped around these two rotating units, and carries by the two rotating unit to move around them, further forming at least one moving viewing plane in the opening of the rigid housing. There are at least one line of light emitting elements arranged parallel to the rotating units and travels constantly through the display opening as the rotating units carry the moving web to rotate around them with constant speed. A control unit inside the housing provides power, display data and control signal to the light emitting elements on the moving web; A communication unit provides the necessary link between the control unit and the moving web so that power, display data and control signal can be passed on to the light emitting elements causing them to display either text, or video image on the moving web, which can be viewed through the opening of the housing, thus creates a single-face display apparatus.

The second aspect of the present invention uses multiple W stationary rotating units, all parallel and spaced apart from each other with flexible web wrapping around them to provide W moving viewing planes to create a W-face display apparatus. Here W has to be any number greater or equal to two.

The third aspect of the present invention describes a scanning method by moving at least one line of light emitting elements through the moving web as described above to create text or video images on the moving viewing plane for viewing.

### BRIEF DESCRIPTION OF THE DRAWINGS

FIG. 1: Simplified three-dimensional view of the present invention.

FIG. 2: Stationary rotating unit.

FIG. 3: Moving unit.

FIG. 4: Communication unit.

FIG. 5: Control unit

FIG. 6: Dead zones in the rotating moving planes:

FIG. 7: Basic building unit

### DETAILED DESCRIPTION OF THE INVENTION

The display apparatus in FIG. 1 has two stationary rotating units 1 driven by motor 3 with bearing 4 to provide smooth and constant rotation. 2 is the moving web, which wraps around the two rotating units forming two moving viewing planes. 7 are the light emitting elements on the moving web. 5 is the control unit. 6 is the communication unit and 8 is the rigid frame with two openings for viewing. 9˜12 and 10˜11 define two moving viewing planes W₁ and W₂ that can be viewed through the two openings of the rigid housing 8.

The rotating unit is moving with a speed of P in the direction as described with the arrow in FIG. 1. The line of light emitting elements 7, preferably to be light emitting diodes, or known as LEDs, which has the ability to carry with it memory storage for at least one whole image frame of the required image display. When it travels to point 9, the control unit will start downloading one page data to the memory buffer and it will be completed way before it reaches point 10. When it reaches point 10, the control unit will order it to display its data in a line-by-line fashion such that the whole page of data will be displayed while the LED line 7 travels from point 10 to point 11. When line 7 travels between point 11 and 12, the control unit can use this time to do any kind of data management and prepare for line 7 to display either the same page information, or a different format of the previous page information, or even downloading a different page information to be displayed between point 12 and point 9. When the LED line 7 reaches point 9 again, it has completed the function of displaying one frame of information through each of the two openings of the present invention. In such an arrangement, in order to maintain the image quality, rotation of the moving web 2 should maintain a certain RPM, such that the human eye cannot perceive the alternation of the light emitting lines 7 and the light emitting elements being sequentially turned on and off. A human eye may perceive the corresponding information displayed on the rotating web 2 due to the persistence of vision. In order to achieve a steady picture without flickering, we need a minimum frame rate of 24. Assuming we want to achieve a frame rate of 100 for a 480×640 pixel matrix display, that means we have to show 100 display image frames consists of 480×640 pixels during a one-second interval. So the above-mentioned process will be repeated 100 times. All this is done within the 1-second interval by manipulating the speed P of the rotating unit and the diameter D of the stationary rotating units, so that this one line of light emitting elements can travel around the two stationary rotating units 100 times within 1 second to complete this task.

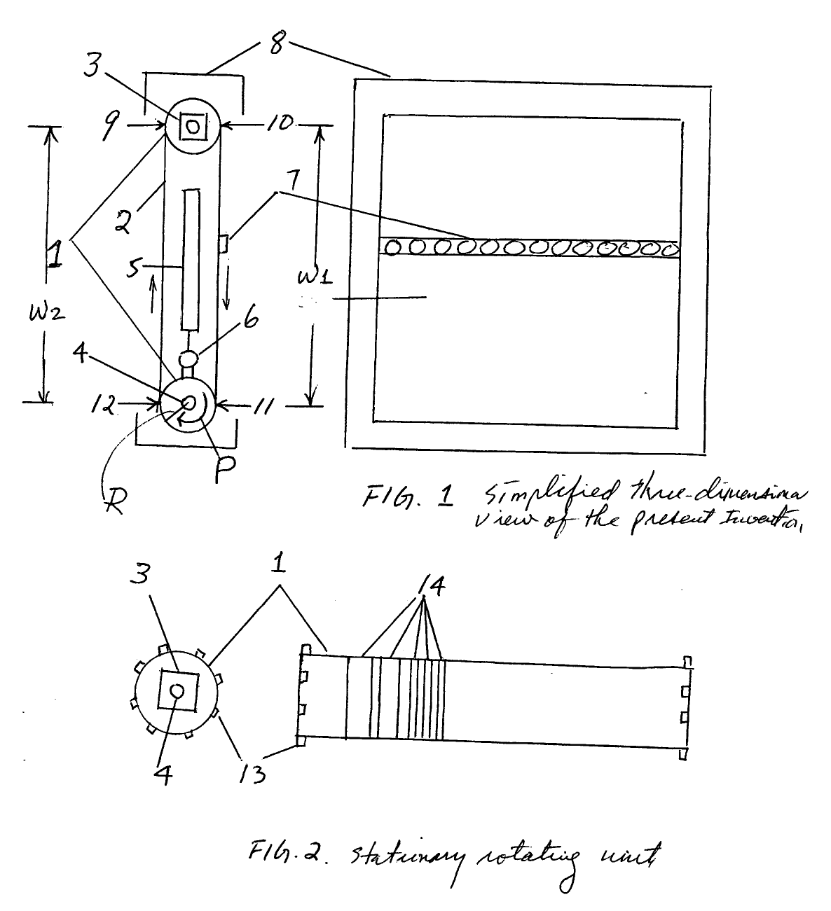

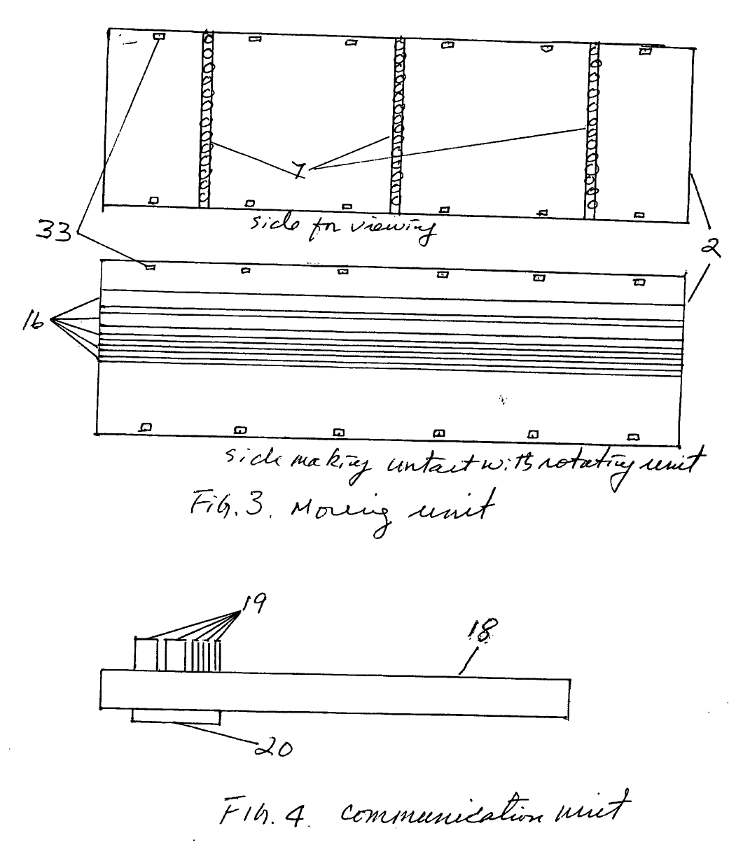

In FIG. 2, 1 is the stationary rotating unit. 3 is the motor providing constant speed to the rotating unit. 4 is the bearing in the rotating unit. 13 is the spikes used to carry the moving web to rotate around the two stationary rotating units and to maintain in a fix trajectory without wobbling. 14 are the imbedded metallic rings to receive power and controlling information from the communication unit and pass them on to the moving web, which has the same pattern of metallic strips that coincide with this ring pattern and can pick up information from them.

In FIG. 3, 2 is the rectangular flexible moving web. It is used to wrap around the two stationary rotating units to form moving viewing plane for viewing. 7 are the light emitting elements arranged in line form, spaced evenly between each other's through out the moving web 2. It is arranged on the side not making contact with the rotating units 1 as described in FIG. 1. 7 can be any point source light emitting elements, such as light emitting diodes, or LEDs. 16 are the imbedded metallic strips forming on the side of the web, which is making contact with the rotating unit 1 as described in FIG. 1. Metallic strips pattern 16 matches with metallic rings pattern 14 on the rotating unit 1 and making constant contact with 14 as it moves around 1 forming two moving viewing planes facing opposite directions as described in FIG. 1. 17 is the means to transfer information received from the metallic strips pattern 16 to the line of light emitting elements situated on the other surface of the moving web 2.

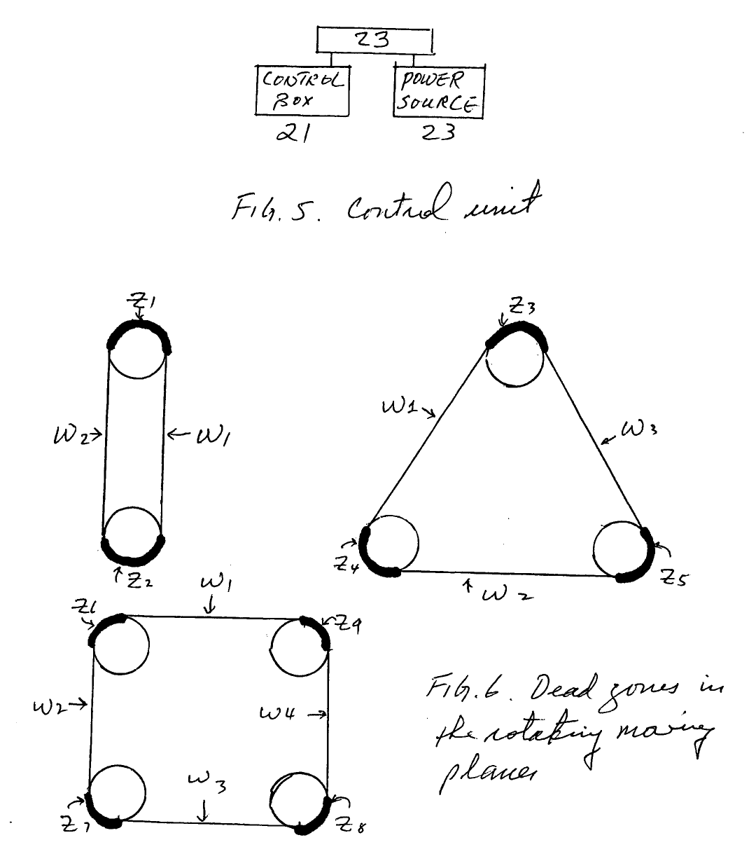

In FIG. 4, the communication unit 6 described in FIG. 1 has an elongate rod 18 made of insolating material and situated parallel to the stationary rotating unit. 19 are the conductive contacts formed in a pattern matching the pattern of the metallic rings imbedded on the rotating unit 1. 19 can be made of any kind of conductive material, such as carbon, copper, etc. 19 is making constant contact with the metallic rings imbedded on rotating unit 1. 20 is the means to receive electronic signals and power source from the control unit 5 as described in FIG. 1, to the communication unit. This can be done through direct wiring or wireless connection with infrared or RF technology.

In FIG. 5, the control unit 5 described in FIG. 1 has an electronic control unit 21 capable of generating all necessary electronic signals that will enable the lines of light emitting elements on moving web 2 to perform its scanning operation to generate the required display images on the moving viewing planes created by the moving web. 21 can be a custom control box or simply a PC with special display control cards. 22 is the power source that will provide the necessary power for the whole system to function. 23 is the means to distribute the power and electronic signals from the control unit to the communication unit 6. This can be accomplished through direct wire connection or combines with wireless connection with infrared or radio frequency technology. The communication unit 6 will transmit the electronic signal and power source first using its conductive contacts 19 to the metallic rings pattern 14 on the rotating units 1. Then all of these signals and power source are transmitted from 14 to 16, which makes constant contact with the metallic ring pattern on rotating unit 1. The line of light emitting elements makes connection to the metallic strips pattern 16 of the web through a simple through-hole connection with either solder, conductive paste, or silver paste.

Another way to do this is to stick with the current method to connect power source to line of light emitting elements, but use either infrared or RF technology to transmit the electronic signal to the line of light emitting elements wirelessly. Infrared and RF signal transmitter can be incorporated in the control unit 5 and infrared and RF signal receiver can be incorporated on the moving web and connected to the line of light emitting elements to directly receive signal from the control unit.

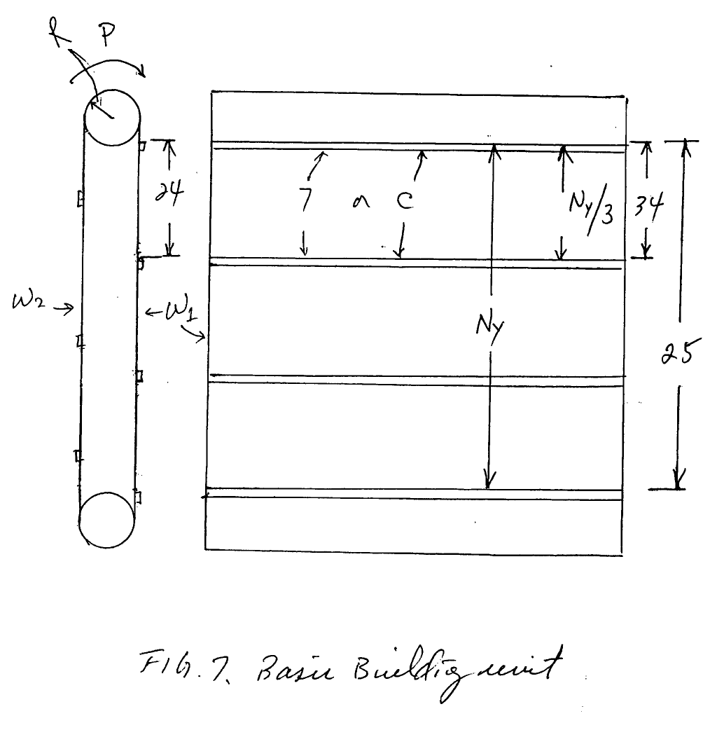

In FIG. 6, The darken area labels Z₁˜Z₉ are defined as Dead Zone, which means it cannot be seen by viewer through the viewing opening of the rigid housing. The number of moving viewing plane W is always equals to the number of rotating units in the present invention and the Dead Zone in each system regardless of how many rotating units or moving viewing planes it consists, is always equals to one circumference of the rotating unit.

In FIG. 7, R is the radius of the rotating unit. It is rotating in a constant speed of P. 24 is a basic display unit which is defined as the circumference of the stationary rotating unit. The length of 24 is L=2πR. One can use one, or multiple basic display units as the basic building unit of the system. To simplify the illustration, we will use one basic unit as the length of the basic building unit of the system.

The basic building unit is defined as the length in the moving web, which consists of at least one basic display unit and have at least one line of light emitting elements 7 arranged parallel to the two rotating units, and can provide n_{y} number of scanning lines by moving the line of light emitting elements between the two rotating units within the length of the basic display unit. To simplify the illustration, here the number of light emitting elements 7 in each of the basic building unit is C, and here we set C=1.

25 is the moving viewing plane as the W₁ defined in FIG. 1. 25 has the length, which can provide the total number of vertical scanning lines N_{y} required to produce the image it needs to display on the moving viewing plane. Here the length is equal to three basic building units and each unit will require to produce N_{y}/3 number of scanning lines by moving that one line of light emitting elements 7 through out the length of L=2πR. So we can see the distance of the scanning line, or the pitch of the display image can be calculated as D_{y}=(2πR)/(N_{y}/3). By fixing the value of R and N_{y}, we can come up with the pitch of the display apparatus D_{y}.

Each display apparatus under the present invention will have a multiple number of basic display units to be divided evenly through out the length of the moving web 2. If there are M basic building units needed for a single-face display, then the total number of basic building units needed for the present invention will be equal to (MW+dead zone)=MW+1. Note here W is defined in FIG. 6 as the total number of moving viewing plane in the display apparatus. Also we had previously defined the basic building unit=the basic display unit to enable us to define the dead zone=1 basic building unit. So in this illustration, W=2 and M=3. So the total length of moving web needed will be equal to 7 basic building units.

Since the speed of the rotating unit is defined as turns per second. When there is only one line of light emitting elements within each of the basic building unit, or in this case, the basic display unit, so for P=1 turn/second, the 7 basic building unit each with its one line of light emitting elements together will complete the scanning of the total number of N_{y} in the two moving planes. Or we can say one frame of the required display image has been scanned. Since the number of image scanned per second is defined as frame rate F. For F=100, P=100 also.

To simplify the illustration, let N_{y}=480 lines, display line pitch D_{y}=4 mm, F=P=100, we will need:

R=D_{y} (N_{y}/3)/2π=D_{y}N_{y}/6π=101.91 mm;

Number of basic building unit=3 per display face;

Line to be scanned in each basic building unit=N_{y}/3=160;

Length of flexible web to form moving web=4479.96 mm;

Number of line of light emitting elements=7.

We also note that if everything stays the same. To increase the number of lines of light emitting elements C in each of the basic building unit will enable us to reduce the speed requirement of the rotating unit to P/C while we still maintain the fixed frame rate F. If we put in 4 lines of light emitting elements in each of the basic building unit, then to get a frame rate of 100, the rotating unit will only need 25 turns per second, as each line of light emitting elements will be require to scan the total of 480 lines with a delay of 40 lines, instead of 160 lines between each two of these lines.

I claim:

1. A display apparatus comprising:
At least two stationary rotating units, which are fixed on a housing with at least one opening for viewing;
A moving unit, which has at least one line of light emitting elements;
Means to provide smooth rotation for the stationary rotating units.
A control unit to provide power and control signals to the light-emitting element on the moving units;
Means to provide communication between the control unit and the moving unit;

2. The at least two stationary rotating units from claim 1 can be a cylindrical rod;

3. The cylindrical rod in claim 2 has a non-electrical-conductive surface.

4. The stationary rotating units from claim 2 are arranged parallel to each other and spaced apart.

5. The at least two stationary rotating units in claim 2 can have a diameter in the range of 0.5″˜100″;

6. The at least two stationary rotating units in claim 2 is further consists of at least one extruding spike on both ends for attaching the moving unit in claim 1 and for rotating this moving unit around the at least two stationary rotating units from claim 1;

7. The at least two stationary rotating units in claim 2 is further consists of efficient bearing on each end for it to carry the moving unit for fast and smooth movement;

8. At least one of the at least two stationary rotating units in claim 2 has multiple metallic rings with various widths imbedded on its cylindrical surface;

9. The means to provide smooth rotation for the stationary rotating unit in claim 1 comprises of motor, and electronic control means;

10. The moving unit in claim 1 comprises of a flexible substrate in dark color, which wraps around the at least two stationary rotating units from claim 1 and rotates by them to form at least one rotating plane defined by the at least two stationary rotating units;

11. The maximum number of rotating plane defined by these rotating units are always equal to the number of rotating units involved in each of the display apparatus.

12. The light emitting elements in claim 1 can be light emitting diodes, or LEDs;

13. The light emitting elements in claim 12 is arranged in a line parallel to the at least two stationary rotating units as in claim 4;

14. The moving unit in claim 10 has holes on both sides of its edges with matching spacing to the extruding spikes on both ends of the stationary rotating units in claim 6;

15. The moving unit in claim 10, on the face where it makes contact with the stationary rotating units, has multiple metallic strips with various widths imbedded on its surface;

16. The imbedded multiple metallic strips from claim 15 align with the imbedded multiple metallic rings on the stationary rotating unit as described in claim 8;

17. The imbedded multiple metallic strips from claim 15 further comprises means to connect them to the light emitting elements in claim 1, which is situated on the other face of the moving unit;

18. The control unit in claim 1 comprises of power source, image source and display signal source and means to control them properly to display image on the moving units lighting elements.

19. The communication unit in claim 1 comprises of at least one static elongate rod parallels to at least one of the stationary rotating units and situated in its proximity. There are extruding conductive contacts situated on its side facing the stationary rotating unit and are arranged in the same pattern as those multiple metallic rings imbedded on the stationary rotating unit as in claim 8, and making contact with them constantly.

20. The elongate rod in claim 19 is made of non-electrical-conductive material.

21. The conductive contacts in claim 19 can be made of good electrical conducting material such as brass, carbon, iron etc;

22. The conductive contacts in claim 19 further comprises means to connect them to the control unit's power source, image source and display signal source;

23. The control unit in claim 18 further comprises means to transmit electronic signal and data to the lines of light emitting elements through infrared or radio frequency devices.

24. A display apparatus comprising:
At least two stationary rotating units, which are fixed on a housing with at least one opening for viewing;
A moving unit, which has at least one line of light emitting elements;
Means to provide smooth rotation for the stationary rotating units.
A control unit to provide power and control signals to the light-emitting element on the moving units;
Means to provide communication between the control unit and the moving unit;
A scanning method based on using at least one line of light emitting elements to display an one page information in a line-by line format as it travels through the at least one display viewing area defined by any two rotating units. Each of the at least one line of light emitting elements will complete the scanning of the total number of scanning lines containing in one image frame, before it will be required to scan the same, or different image frame.

25. The line of light-emitting elements in claim 24 has the capability to store the display information of one whole image frame.

26. The line of light emitting elements in claim 24 has the capability to display information of one whole image frame W times through the W display viewing openings, as W equals to the number of stationary rotating units associated with the display apparatus.
